(19) United States
(12) Patent Application Publication
(10) Pub. No.: US 2026/0342120 A1
(43) Pub. Date: Oct. 29, 2026

(54) ENERGY STORAGE MODULE, POWER SUPPLY SYSTEM, AND METHOD OF CONTROLLING THE ENERGY STORAGE MODULE

(71) Applicant: DELTA ELECTRONICS (THAILAND) PUBLIC COMPANY LIMITED, Amphur Muang (TH)

(72) Inventors: Kai DONG, Shanghai (CN); Min XU, Shanghai (CN); Yuming MA, Shanghai (CN); Hui HUANG, Shanghai (CN)

(21) Appl. No.: 19/338,696

(22) Filed: Sep. 24, 2025

(30) Foreign Application Priority Data
Apr. 23, 2025 (CN) 202510523425.9

(51) Int. Cl. H02J 7/00; H02J 1/102; H02J 7/34; H02J 7/90; H02M 3/158

(52) U.S. Cl. CPC H02J 7/855; H02J 1/102; H02J 7/345; H02J 7/933; H02M 3/1582; H02J 2207/20; H02J 2207/50

(57) ABSTRACT

An energy storage module, a power supply system, and a method of controlling the energy storage module are disclosed. The energy storage module includes a bidirectional DC-to-DC converter and an energy storage unit. A first terminal of the bidirectional DC-to-DC converter is connected to the energy storage unit. The method includes: controlling the energy storage module to operate in a charging mode when a load of a power module connected to a second terminal of the bidirectional DC-to-DC converter is in an idle state, and selecting a full power compensation approach or a reduced power compensation approach to compensate an input current of the power module according to a specific condition.

### BACKGROUND

### Technical Field

The present disclosure relates to a field of power supplies, and more particularly to an energy storage module, a power supply system, and a method of controlling the energy storage module.

### Description of Related Art

The statements in this section merely provide background information related to the present disclosure and do not necessarily constitute prior art.

In applications of server power supplies, the common structure of the power module (also referred to as “power supply unit”, PSU) is a two-stage topology: the front stage is a power factor correction circuit (PFC), and the rear stage is a direct-current to direct-current (DC-to-DC) converter.

With the development of AI (artificial intelligence) and high-performance computing, the power consumption of components such as graphics processing units (GPUs) and central processing units (CPUs) in servers is also increasing. As the demand for high-performance computing increases, server power supply systems need to cope with higher power requirements, higher heat dissipation capabilities, and more stable voltage control requirements, and require more intelligent power management systems to ensure their stable operation. Since AI (artificial intelligence) loads frequently experience large fluctuations, the output power of the server power supply fluctuates dramatically. Therefore, discontinuities in the AC input waveform may introduce undesired noise into the power supply network, thereby impacting the power quality on the input side. In the prior art, energy storage modules such as capacitors are usually added to compensate for the fluctuation of input current and achieve the effect of peak shaving and valley filling.

However, the AI load fluctuates greatly, with short idle time and long idle time, and the energy that can be compensated by the energy storage capacitor is limited. If the idle time is long, it may not be possible to fully compensate for all the idle time, resulting in a sudden change in the input current Iin. Please refer to FIG. 1, which shows a schematic waveform diagram of an input current that suddenly changes when the load is in an idle state. At time t1, the load begins to be in an idle state. In FIG. 1, a load current Iload directly drops to zero as an example, but it is only an example and the present disclosure is not limited thereto. In other words, when the load current Iload is a very small value for a long period of time, the value is not necessarily constant, and it may even have a small pulsation, which can be considered as the load being in an idle state. For example, for the AI load of the server power supply, it usually includes a high-frequency dynamic mode, and the load fluctuates around the average load in the high-frequency dynamic mode. Therefore, if the load is lower than the average load for a long time, it may be determined as an idle state. Therefore, the load being in an idle state cannot be limited to the example shown in FIG. 1, but should be determined according to the actual application.

When the load starts to be in the idle state at time t1, the input current Iin is kept unchanged by charging the energy storage capacitor during the period from time t1 to time t2. However, after time t2, the energy storage capacitor is fully charged and can no longer compensate the input current Iin, and therefore the input current Iin changes suddenly. Until time t3, the load returns to the high-frequency dynamic mode, that is, the load enters the normal operation status, as shown by the load current Iload in FIG. 1, and therefore the energy storage capacitor starts to compensate the input current Iin again. Therefore, during the period from time t2 to time t3, the input current Iin changes suddenly, and this sudden change is not desirable.

Therefore, how to design an energy storage module, a power supply system, and a method of controlling the energy storage module to avoid a sudden change in the input current of the power module when the load is in an idle state has become a critical topic in this field.

### SUMMARY

An objective of the present disclosure is to provide a method of controlling an energy storage module to solve the problems of existing technologies.

In order to achieve the above-mentioned objective, the energy storage module includes a bidirectional DC-to-DC converter and an energy storage unit. A first terminal of the bidirectional DC-to-DC converter is connected to the energy storage unit. The method comprising: controlling the energy storage module to operate in a charging mode when a load of a power module connected to a second terminal of the bidirectional DC-to-DC converter is in an idle state, and selecting a full power compensation approach or a reduced power compensation approach to compensate an input current of the power module according to a specific condition.

In one embodiment, the method further includes: in the full power compensation approach, controlling an amplitude of the input current to maintain the amplitude of the input current unchanged before the load is in the idle state.

In one embodiment, the method further includes: in the reduced power compensation approach, controlling an amplitude of the input current to be lower than the amplitude of the input current before the load is in the idle state and to slowly change.

In one embodiment, the method further includes: in the reduced power compensation approach, controlling charging power of the energy storage unit to reduce so as to extend a charging time of the energy storage unit.

In one embodiment, the method further includes: determining that the load is in the idle state when a duration that the energy storage module enters the charging mode exceeds a preset time.

In one embodiment, the specific condition is determined by at least one of a duration of the idle state of the load, a remaining compensable energy of the energy storage unit, and a preset compensation time.

In one embodiment, in a condition that the specific condition is determined by the duration of the idle state of the load, when the duration of the idle state of the load is less than a first time threshold, the full power compensation approach is selected; when the duration of the idle state of the load is greater than the first time threshold, the reduced power compensation approach is selected, or the full power compensation approach is selected first to compensate for a second time threshold and the reduced power compensation approach is then selected when the load is still in the idle state.

In one embodiment, in a condition that the specific condition is determined by the remaining compensable energy of the energy storage unit, when the remaining compensable energy exceeds a first energy threshold, the full power compensation approach is selected; when the remaining compensable energy is lower than the first energy threshold, the reduced power compensation approach is selected, or the full power compensation approach is selected first and the reduced power compensation approach is then selected when the remaining compensable energy is lower than a second energy threshold.

In one embodiment, in a condition that the specific condition is determined by the preset compensation time and the remaining compensable energy of the energy storage unit, when the remaining compensable energy is sufficient to keep the input current unchanged within the preset compensation time, the full power compensation approach is selected; when the remaining compensable energy is insufficient to keep the input current unchanged within the preset compensation time, the reduced power compensation approach is selected, or the full power compensation approach is selected first and the reduced power compensation approach is then selected.

In one embodiment, the method further includes: calculating the remaining compensable energy of the energy storage unit in real time; acquiring a remaining compensation time according to a current charging power and the remaining compensable energy; acquiring a time still required for compensation according to a difference between the preset compensation time and a compensated time; adjusting the compensation approach according to a relationship between the remaining compensation time and the time still required for compensation, wherein when the remaining compensation time is greater than the time still required for compensation, the full power compensation approach is selected; when the remaining compensation time is less than the time still required for compensation, the full power compensation approach is switched to the reduced power compensation approach so that the remaining compensation time is not less than the time still required for compensation.

In one embodiment, the preset compensation time is a known time of the idle state of the load.

In one embodiment, the known time of the idle state of the load is predicted according to an artificial intelligence algorithm.

In one embodiment, the preset compensation time is a specified maximum duration of the load in the idle state.

In one embodiment, the method further includes: controlling an operation state of the energy storage module according to a reference signal and a current-sharing bus signal provided by the power module.

In one embodiment, the reference signal represents an average power of the power module.

In one embodiment, the reference signal is acquired by processing the current-sharing bus signal.

In one embodiment, the method further includes: in the full power compensation approach, acquiring a current-sharing bus sampling signal by sampling the current-sharing bus signal, generating a current reference signal corresponding to the bidirectional DC-to-DC converter according to a difference between the reference signal and the current-sharing bus sampling signal, and generating a control signal for controlling the bidirectional DC-to-DC converter according to the current reference signal and an inductor current of the bidirectional DC-to-DC converter so as to maintain the input current unchanged.

In one embodiment, the method further includes: in the reduced power compensation approach, acquiring a current-sharing bus sampling signal by sampling the current-sharing bus signal, generating a current reference signal corresponding to the bidirectional DC-to-DC converter according to a difference between the reference signal and the current-sharing bus sampling signal, and generating a control signal for controlling the bidirectional DC-to-DC converter according to the current reference signal and an inductor current of the bidirectional DC-to-DC converter, wherein the reduced power compensation approach is implemented by limiting an amplitude of the current reference signal.

In one embodiment, the current reference signal is set not to exceed to a ratio of a power limit value and a voltage of the energy storage unit, and the reduced power compensation approach is implemented by reducing the power limit value.

Another objective of the present disclosure is to provide an energy storage module to solve the problems of existing technologies.

In order to achieve the above-mentioned objective, the energy storage module includes a bidirectional DC-to-DC converter and an energy storage unit. A first terminal of the bidirectional DC-to-DC converter is connected to the energy storage unit, and a second terminal of the bidirectional DC-to-DC converter is connected to an output terminal of a power module; each energy storage module further includes a controller, and the controller executes the above-mentioned method.

Further another objective of the present disclosure is to provide a power supply system to solve the problems of existing technologies.

In order to achieve the above-mentioned objective, the power supply system includes at least one power module and at least one energy storage module. Each energy storage module has an output terminal of each power module is connected in parallel to a load, wherein each power module converts its own output current into a voltage signal to a current-sharing bus. An output terminal of each energy storage module is connected together, and each energy storage module includes a bidirectional DC-to-DC converter and an energy storage unit. A first terminal of the bidirectional DC-to-DC converter is connected to the energy storage unit, and a second terminal of the bidirectional DC-to-DC converter is connected to the output terminal of the power module. Each energy storage module further includes a controller, and the controller executes the above-mentioned method; wherein the voltage signal on the current-sharing bus is the current-sharing bus signal.

In one embodiment, the at least one power module is disposed in the same power shelf; the at least one energy storage module is disposed in the same power shelf.

Accordingly, the present disclosure has the following features and advantages: selecting either the full power compensation approach or the reduced power compensation approach based on specific conditions to compensate the input current of the power module enables the input current to remain unchanged or fluctuate more gradually, thereby reducing the impact on the power grid.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a schematic waveform diagram of an input current that suddenly changes when the load is in an idle state.

FIG. 2 is a block circuit diagram of a power supply system having a power module combined with an energy storage module according to the present disclosure.

FIG. 3 is a circuit diagram of the energy storage module according to the present disclosure.

FIG. 4 is a schematic block diagram of a single power module and a single energy storage module according to the present disclosure.

FIG. 5 is a schematic block diagram of multiple power modules and multiple energy storage modules according to the present disclosure.

FIG. 6 is a block diagram of a control loop of an energy storage module according to the present disclosure.

FIG. 7 is a schematic diagram of performing a full power compensation approach to an input current of the power module according to the present disclosure.

FIG. 8 is a schematic diagram of performing a reduced power compensation approach to the input current of the power module according to the present disclosure.

FIG. 9 is a flowchart of a method of controlling the energy storage module according to the present disclosure.

FIG. 10A is a flowchart of the method of selecting the full power compensation approach or the reduced power compensation approach based on a duration of the idle state of the load according to the present disclosure.

FIG. 10B is a flowchart of the method of selecting the full power compensation approach or the reduced power compensation approach based on a remaining compensable energy of the energy storage unit according to the present disclosure.

FIG. 10C and FIG. 10D are flowcharts of the method of selecting the full power compensation approach or the reduced power compensation approach based on a preset compensation time and the remaining compensable energy of the energy storage unit according to the present disclosure.

### DETAILED DESCRIPTION

Reference will now be made to the drawing figures to describe the present disclosure in detail. It will be understood that the drawing figures and exemplified embodiments of present disclosure are not limited to the details thereof.

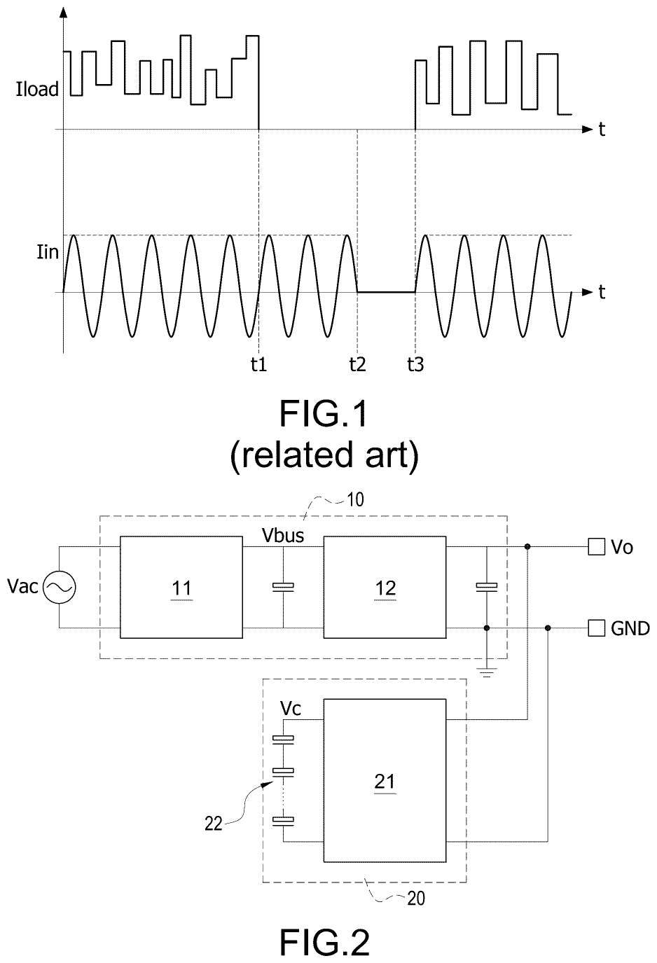

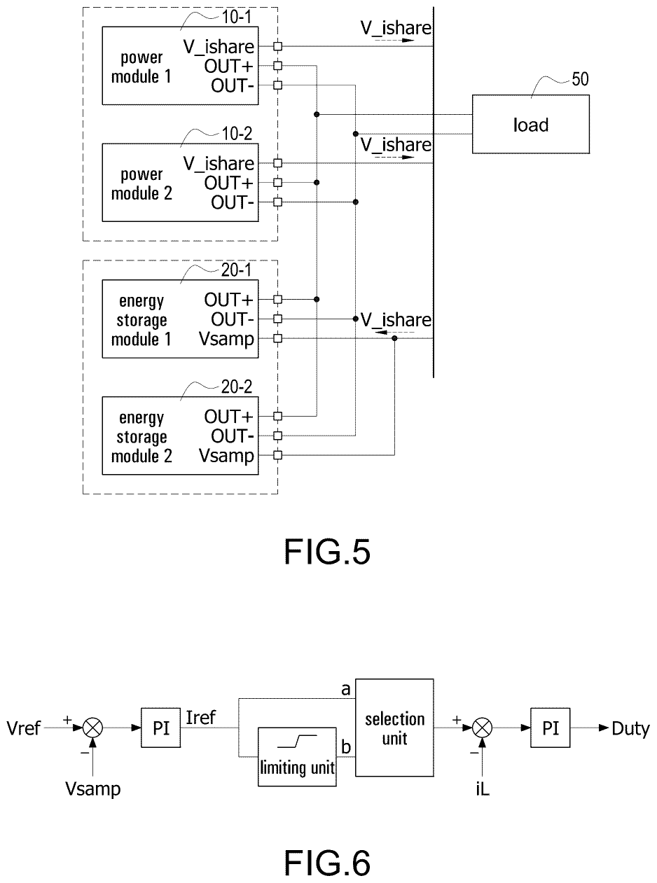

Please refer to FIG. 2, which shows a block circuit diagram of a power supply system having a power module combined with an energy storage module according to the present disclosure. The power supply system includes at least one power module (also referred to as “power supply unit”, PSU) 10 and at least one energy storage module 20. The power module 10 includes, for example but not limited to, a front-stage power factor correction circuit (PFC) 11 and a rear-stage direct-current to direct-current (DC-to-DC) converter 12. The front-stage power factor correction circuit (PFC) 11 receives an alternating-current (AC) power source Vac, and converts the AC power source Vac into a DC power source. The DC power source is then converted by the rear-stage DC-to-DC converter 12 to be output. In particular, an output side of the rear-stage DC-to-DC converter 12 is connected to a load 50 (may be referred in FIG. 4 or FIG. 5) to supply power to the load 50. In some embodiment, the rear-stage DC-to-DC converter 12 may also be a single-stage AC-to-DC converter.

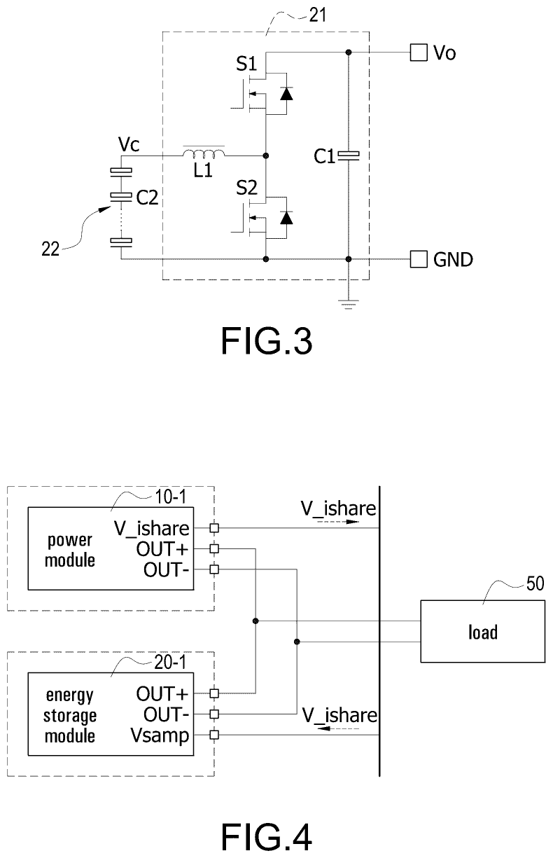

The energy storage module 20 mainly includes a bidirectional DC-to-DC converter 21 and an energy storage unit 22. The bidirectional DC-to-DC converter 21 may have many structures. The present disclosure is described by taking a common bidirectional buck/boost converter as an example, but the present disclosure is not limited thereto. Similarly, the energy storage unit 22 may be implemented by many energy storage components with energy storage function. The present disclosure is described by taking the energy storage component as the energy storage capacitor C2 (may be referred in FIG. 3) as an example, but the present disclosure is not limited thereto. In addition, the energy storage capacitor C2 may be, for example, a supercapacitor.

Specifically, as shown in FIG. 2, each energy storage module 20 includes a bidirectional DC-to-DC converter 21 and an energy storage unit 22. A first terminal of the bidirectional DC-to-DC converter 21 is connected to the energy storage unit 22. A second terminal of the bidirectional DC-to-DC converter 21 is connected to the output terminal of the power module 10. Each energy storage module 20 further includes a controller, and the controller is used to control the energy storage module 20.

Specifically, if the load 50 is too heavy and without the energy storage module 20, an input current of the power module 10 will be too high. When the energy storage module 20 is added, the energy storage module 20 is controlled to operate in a discharging mode, so that the energy storage unit 22 releases energy to the load 50 through the bidirectional DC-to-DC converter 21, and supplies power to the load 50 together with the power module 10, thereby maintaining the input current of the power module 10 unchanged. On the contrary, when the load 50 is too light, the energy storage module 20 is controlled to operate in a charging mode, so that the excess input power is delivered to the energy storage unit 22 through the bidirectional DC-to-DC converter 21 to charge the energy storage unit 22, thereby maintaining the input current of the power module 10 unchanged. Therefore, by providing or receiving current through the energy storage module 20, the output current of the power module 10 does not need to rapidly increase or decrease in a short period of time. As a result, the power module 10 does not need to quickly increase or decrease the current drawn from its input power source so that the input current of the power module 10 can be maintained unchanged, thereby reducing the impact on the power grid.

Please refer to FIG. 3, which shows a circuit diagram of the energy storage module according to the present disclosure. As mentioned above, the bidirectional DC-to-DC converter 21 of the energy storage module 20 is described by taking a bidirectional buck/boost converter as an example. The bidirectional DC-to-DC converter 21 includes an inductor L1, a first switch S1, a second switch S2, and a capacitor C1. When the energy storage module 20 operates in the discharging mode, the bidirectional DC-to-DC converter 21 operates in a boost state; when the energy storage module 20 operates in the charging mode, the bidirectional DC-to-DC converter 21 operates in a buck state. It should be noted that, in other embodiments, the opposite situation may also occur, which depends on the configuration of the energy storage unit 22.

Please refer to FIG. 4, which shows a schematic block diagram of a single power module and a single energy storage module according to the present disclosure. The power module 10-1 correspondingly converts its own output current into a voltage signal and connects it to a current-sharing bus. The voltage signal on the current-sharing bus is referred to as a current-sharing bus signal V_ishare. For example, according to the specification requirements of ORV3 (Open Rack Standard V3 or Open Compute Project Rack Standard V3), when the power module 10-1 generates 50% of the rated current, the current-sharing bus signal V_ishare is 3.5 volts; when the power module 10-1 generates 100% of the rated current, the current-sharing bus signal V_ishare is 7 volts. The energy storage module 20-1 can acquire the corresponding load information by simply sampling the current-sharing bus signal V_ishare on the current-sharing bus. In general, the current-sharing bus signal V_ishare is a signal that is positively correlated with the current value of the output current of the power module 10-1, so that the energy storage module 20-1 can estimate the condition of the load 50 according to the current-sharing bus signal V_ishare provided by the power module 10-1. For example, when the signal value of the current-sharing bus signal V_ishare is large, it represents that the load 50 needs more power. On the contrary, when the signal value of the current-sharing bus signal V_ishare is small, it represents that the load 50 needs less power. When a change rate of the signal value of the current-sharing bus signal V_ishare is large, it represents that the load 50 rapidly increases or decreases. Therefore, by utilizing the current-sharing bus signal V_ishare, there is no need to use additional devices to sample the output current of the power module 10-1 to acquire the load information. Usually, since the power module 10-1 is a packaged as a whole and no position is reserved for current sampling, the load information is cleverly acquired by utilizing the existing information of the power module 10-1.

Please refer to FIG. 5, which shows a schematic block diagram of multiple power modules and multiple energy storage modules according to the present disclosure. Compared with the single power module 10-1 and the single energy storage module 20-1 shown in FIG. 4, FIG. 5 illustrates that multiple (i.e., two) power modules 10-1,10-2 in parallel and multiple (i.e., two) energy storage modules 20-1,20-2 in parallel work in coordination. In the parallel power module structure, output terminals of each power module are connected together to the load 50, and output terminals of each energy storage module are connected together to the output terminals of each power module. Also, each power module 10-1,10-2 will convert its own output current into a corresponding voltage signal, and multiple voltage signals will be connected to a common current-sharing bus. In general, for a system with multiple power modules connected in parallel, there is usually a requirement for current sharing, and therefore each power module 10-1,10-2 will compare its own output current with the current-sharing bus signal V_ishare on the common current-sharing bus to make corresponding adjustments to achieve the purpose of current sharing. For example, if the voltage signal corresponding to the output current of the power module 10-1 is lower than the current-sharing bus signal V_ishare on the current-sharing bus, it represents that the current supplied by the power module 10-1 is less. In this condition, the control circuit will control the power module 10-1 to generate more power to increase its output current, and vice versa. Therefore, the currents output by the power modules 10-1,10-2 tend to be the same to achieve the purpose of current sharing, thereby realizing load sharing, that is, the current-sharing bus signal V_ishare may represent the average load information of multiple power modules.

Furthermore, by the coordinated operation of the two energy storage modules 20-1,20-2 and the two power modules 10-1,10-2, when the load 50 is too heavy, the energy storage modules 20-1,20-2 are controlled to operate in the discharging mode to release energy to the load 50; alternatively, when the load 50 is too light, the energy storage modules 20-1,20-2 are controlled to operate in the charging mode, so that the excess input power charges the energy storage units 22 of the energy storage modules 20-1,20-2, thereby maintaining the input currents of the power modules 10-1,10-2 unchanged. In addition, although two power modules and two energy storage modules are used as an example for explanation, it should be understood that the number of power modules and the number of energy storage modules are not in a one-to-one correspondence, and both can be designed according to the requirements of the load 50. In other embodiments, multiple power modules are connected in parallel and placed in the same power shelf, and multiple energy storage modules are connected in parallel and placed in the same power shelf, and both are placed in a power rack.

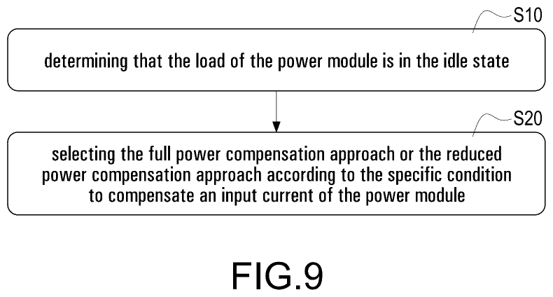

Please refer to FIG. 9, which shows a flowchart of a method of controlling the energy storage module according to the present disclosure. The method of controlling the energy storage module includes: first, determining that a load 50 of the power module is in an idle state (step S10). The power module takes the power module 10 shown in FIG. 2 as an example, but the present disclosure is not limited thereto. It should be understood that the energy storage module 20 is controlled by the controller of the energy storage module 20 to switch between the charging mode and the discharging mode according to the change of the load 50. When the load 50 becomes lighter, the energy storage module 20 enters the charging mode. When the time for the energy storage module 20 to enter the charging mode exceeds the preset time, it can be determined that the load 50 is in the idle state. There are many other approaches to determine and identify that the load 50 is in an idle state. For example, the time of each load change is predicted by an artificial intelligence (AI) algorithm, and the predicted information is transmitted to the energy storage module 20 so that the energy storage module 20 can directly determine the state of the load 50, including whether the load 50 is in an idle state. However, the above are only examples and are not intended to limit the present disclosure.

After determining that the load 50 is in the idle state, the method of controlling the energy storage module further includes: selecting the full power compensation approach or the reduced power compensation approach according to a specific condition to compensate the input current Iin of the power module 10 (step S20). Due to the limitation of a withstand voltage of the energy storage capacitor C2, the energy that the energy storage unit 22 can store is limited. If the load 50 remains in the idle state for an extended period of time, it may become impossible to maintain the amplitude of the input current Iin unchanged before the load is in the idle state. Therefore, step S20 is required to compensate the input current Iin in different approaches according to different situations to ensure that the input current Iin will not change suddenly during the entire idle state.

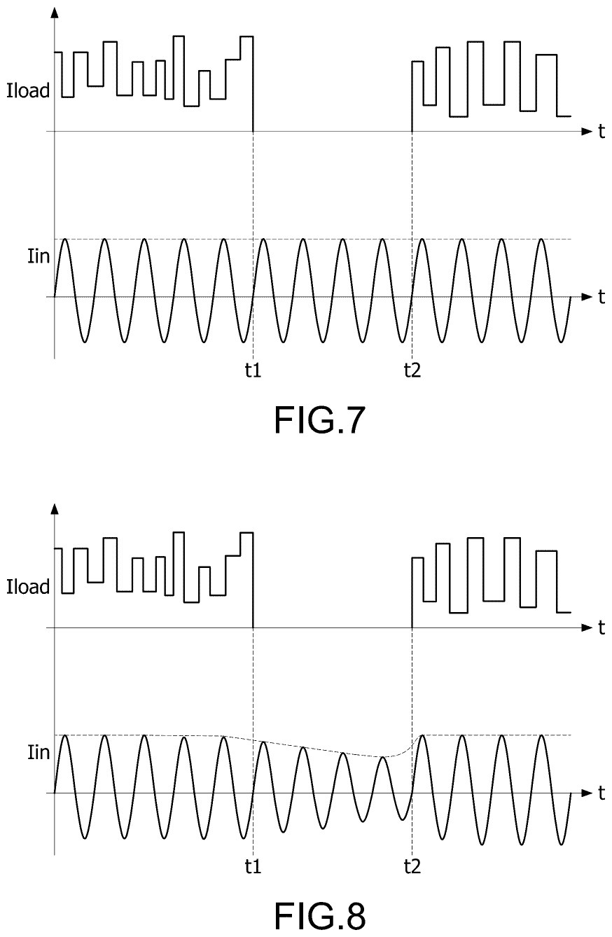

Please refer to FIG. 7, which shows a schematic diagram of performing a full power compensation approach to an input current of the power module according to the present disclosure. As shown in FIG. 7, in the full power compensation approach, the amplitude of the input current Iin is controlled unchanged as the amplitude of the input current Iin before the load 50 is in the idle state. As shown in FIG. 7, during the period from time t1 to time t2, the load 50 is in the idle state. By compensating the input current Iin by the full power compensation approach, the amplitude of the input current Iin can be controlled unchanged as the amplitude of the input current Iin before the load 50 is in the idle state.

Please refer to FIG. 8, which shows a schematic diagram of performing a reduced power compensation approach to the input current of the power module according to the present disclosure. As shown in FIG. 8, in the reduced power compensation approach, the amplitude of the input current Iin is controlled to be lower than the amplitude of the input current Iin before the load 50 is in the idle state and changes slowly. In addition, in the reduced power compensation approach, the charging time of the energy storage unit 22 can be extended by controlling charging power of the energy storage unit 22 to reduce. In other words, the energy storage unit 22 is charged with a lower power so that the time required to fully charge the energy storage unit 22 may be extended and the amplitude of the input current Iin changes more slowly.

Specifically, the above-mentioned “specific condition” for compensating the input current Iin of the power module 10 may be determined by at least one of a duration of the idle state of the load 50, a remaining compensable energy of the energy storage unit 22, and a preset compensation time. However, the present disclosure is not completely limited to these three as the specific conditions. All factors related to the compensation of the input current Iin should be considered by the present disclosure, and the following will be described in detail.

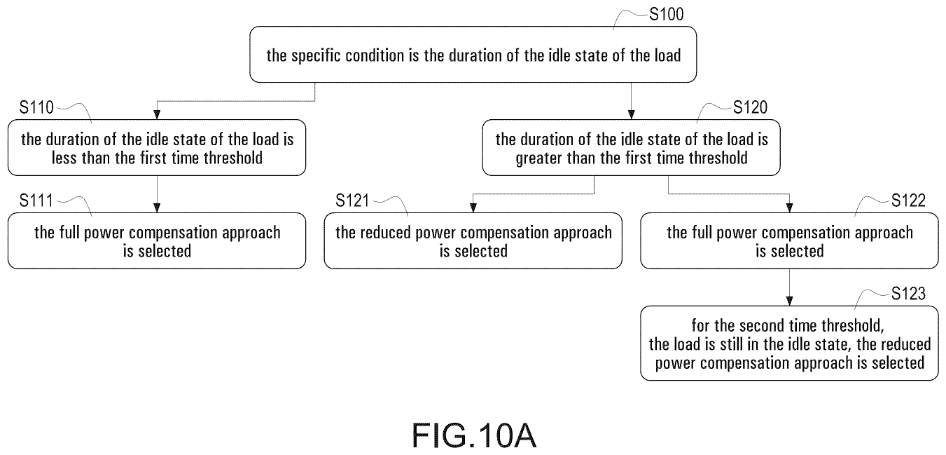

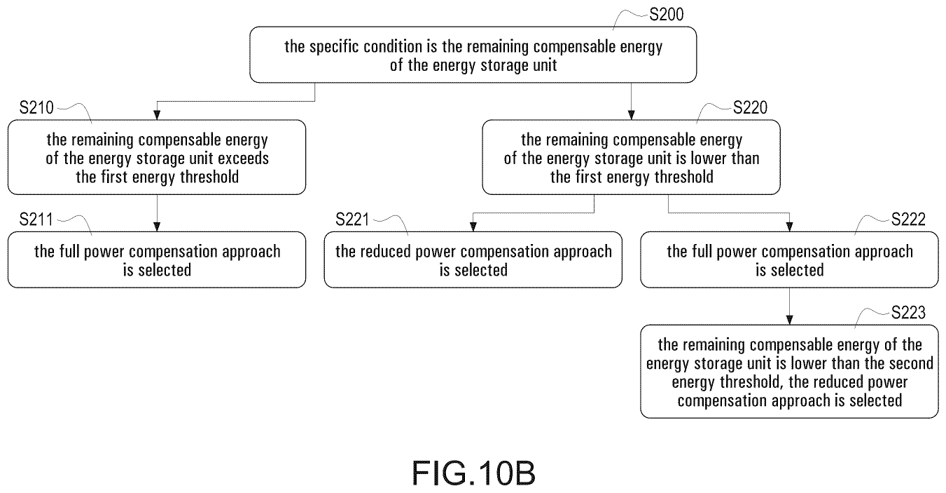

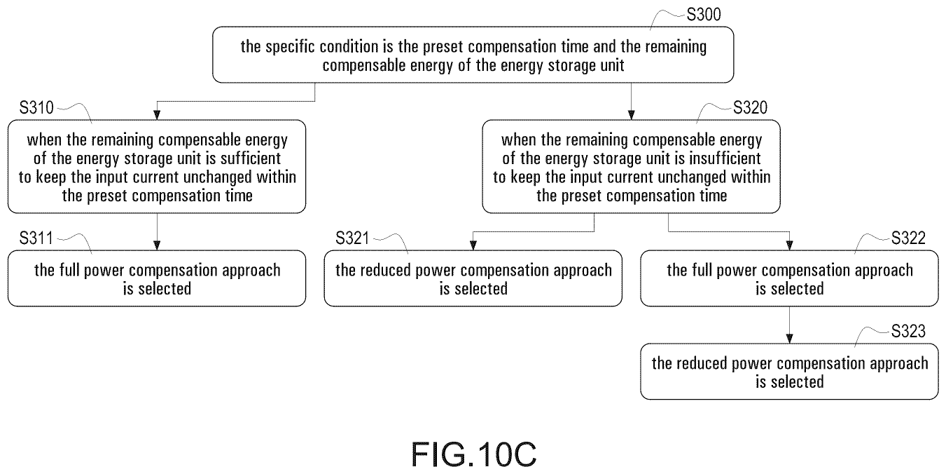

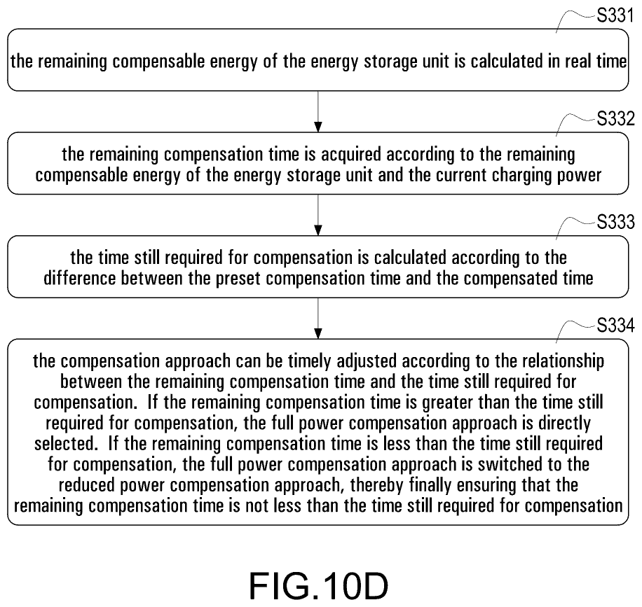

Take the duration of the idle state of the load 50 as an example. When the duration of the idle state of the load 50 is short, the full power compensation approach can be directly selected so that the amplitude of the input current Iin can be maintained unchanged (that is, the input current Iin does not change suddenly) during the short duration of the idle state. When the duration of the idle state of the load 50 is long, the reduced power compensation approach can be directly selected, or the full power compensation approach can be selected first, and then the reduced power compensation approach can be selected. Therefore, it is possible to avoid that the period for applying the full power compensation approach is too long and the energy storage module 20 has no ability to compensate, thereby preventing a sudden fluctuation in the input current Iin caused by the interruption of compensation by the energy storage unit 22. For example, referring to FIG. 10A, when the duration of the idle state of the load 50 is less than a first time threshold (step S110), the full power compensation approach is selected (step S111). When the duration of the idle state of the load 50 is greater than the first time threshold (step S120), the reduced power compensation approach is selected (step S121), or the full power compensation approach is selected first (step S122), and then the reduced power compensation mode is selected. For example, after the full power compensation approach is selected to compensate for a second time threshold, if it is determined that the load 50 is still in the idle state, the reduced power compensation approach can be selected instead (step S123). It should be understood that the first time threshold and the second time threshold may be set according to actual conditions, and the present invention is not limited thereto.

Take the remaining compensable energy of the energy storage unit 22 as an example. When the remaining compensable energy of the energy storage unit 22 is high, the full power compensation approach can be directly selected. That is, the amplitude of the input current Iin can be maintained unchanged under the condition that the remaining compensable energy of the energy storage unit 22 is sufficient. When the remaining compensable energy of the energy storage unit 22 is low, the reduced power compensation approach can be directly selected, or the full power compensation approach can be selected first, and then the reduced power compensation approach can be selected. Therefore, it is possible to prevent a sudden fluctuation in the input current Iin caused by the interruption of compensation by the energy storage unit 22. In particular, the remaining compensable energy of the energy storage unit 22 can be calculated by a voltage Vc of the energy storage unit 22. For example, providing that the voltage Vc at the beginning of the compensation is 30 volts and the maximum voltage Vmax of the energy storage unit 22 is 40 volts, the maximum value of the remaining compensable energy during the current charging cycle can be calculated, which equals to CVmax²/2-CVc²/2, where C is the whole capacitance of the energy storage unit 22. In some embodiments, referring to FIG. 10B, when the remaining compensable energy exceeds a first energy threshold (step S210), the full power compensation approach is selected (step S211). When the remaining compensable energy is lower than the first energy threshold (step S220), the reduced power compensation approach is selected (step S221), or the full power compensation approach is selected first (step S222), and then the reduced power compensation approach is selected. In other embodiments, the remaining compensable energy of the energy storage unit 22 can be calculated in real time to adjust the compensation approaches at any time. For example, the power for charging the energy storage unit 22 is calculated in real time and integrated to acquire the energy that has been compensated by the energy storage unit 22. By subtracting the compensated energy from the maximum remaining compensable energy of the energy storage unit 22, the real-time remaining compensable energy of the energy storage unit 22 can be acquired, and the compensation approach may be adjusted based on this value. For example, the full power compensation approach is selected for compensation first, and the remaining compensable energy of the energy storage unit 22 is calculated in real time. When the remaining compensable energy of the energy storage unit 22 is lower than a second energy threshold, the reduced power compensation approach is selected for compensation (step S223). In particular, the second energy threshold is smaller than the first energy threshold. It should be understood that both the first and second energy thresholds may be set according to actual conditions, and the present invention is not limited thereto.

Take the preset compensation time and the remaining compensable energy of the energy storage unit 22 as an example, and please refer to FIG. 10C. When the remaining compensable energy of the energy storage unit 22 is sufficient to keep the input current Iin unchanged within the preset compensation time (step S310), the full power compensation may can be directly selected (step S311). When the remaining compensable energy of the energy storage unit 22 is insufficient to keep the input current Iin unchanged within the preset compensation time (step S320), the reduced power compensation approach can be directly selected (step S321), or the full power compensation approach can be selected first (step S322), and then the reduced power compensation approach can be selected (step S323). Therefore, it is possible to prevent a sudden fluctuation in the input current Iin caused by the interruption of compensation by the energy storage unit 22.

Specifically, the preset compensation time is an expected compensation time. In some embodiments, the preset compensation time is a known time of the idle state of the load 50. In particular, the known time of the idle state of the load 50 may be predicted according to an artificial intelligence (AI) algorithm, especially for load changes with regular operation. For example, if the known time of the idle state of the load 50 predicted by the artificial intelligence algorithm is longer and exceeds the remaining compensation time of the energy storage unit 22, the reduced power compensation approach can be directly selected, or the full power compensation approach can be selected first, and then the reduced power compensation approach can be selected. In other embodiments, the preset compensation time is a specified maximum duration of the load 50 in the idle state (for the power module, the maximum duration of the load 50 in the idle state is usually specified, as long as the energy storage module 20 can maintain the input current of the power module 20 unchanged during this period of time). Referring to FIG. 10D, first, the remaining compensable energy of the energy storage unit 22 is calculated in real time (step S331). Afterward, according to the remaining compensable energy of the energy storage unit 22 and the current charging power, the remaining compensation time (for example, the remaining compensation time is equal to the ratio of the remaining compensable energy to the current charging power) is acquired in real time (step S332), and then a time still required for compensation is calculated according to the difference between the preset compensation time and the compensated time (step S333), so that the compensation approach can be timely adjusted according to the relationship between the remaining compensation time and the time still required for compensation. If the remaining compensation time is greater than the time still required for compensation, the full power compensation approach is directly selected. If the remaining compensation time is less than the time still required for compensation, the full power compensation approach is switched to the reduced power compensation approach, and when the reduced power compensation approach is selected, the value that the compensation power needs to be reduced to still needs to be adjusted at any time according to the relationship between the remaining compensation time and the time still required for compensation, thereby finally ensuring that the remaining compensation time is not less than the time still required for compensation (step S334).

Incidentally, the operation of first selecting the full power compensation approach and then selecting the reduced power compensation approach may be to first perform full power compensation approach for a certain period of time, or first perform full power compensation approach until the remaining compensable energy reaches a certain value and then perform the reduced power compensation approach, etc., and the present invention is not limited thereto.

In addition, under normal conditions, the compensation approach for input current Iin should be based on the principle of the full power compensation approach as a priority and the reduced power compensation approach as a secondary, either by adopting a single compensation method (i.e., the full power compensation approach) or by combining both approaches (i.e., the full power compensation approach together with the reduced power compensation approach). In other words, the compensation approach for input current Iin is mainly based on the compensation approach that can maintain the amplitude of the input current unchanged, while the compensation approach for reducing the amplitude of the input current is a secondary choice. Therefore, it can be seen from the above that the full power compensation approach is mainly to maintain the input current Iin without fluctuation, while reduced power compensation approach is mainly to extend the time of compensating the input current Iin and mitigate the change of the input current Iin.

Please refer to FIG. 6, which shows a block diagram of a control loop of an energy storage module according to the present disclosure. The current-sharing bus signal V_ishare is sampled to acquire a current-sharing bus sampling signal Vsamp, and the operation mode of the energy storage module 20 is controlled according to a difference between a reference signal Vref and the current-sharing bus sampling signal Vsamp. In addition, when the energy storage module 20 is in a standby mode, that is, a pre-charging process of the energy storage module 20 has been completed, the energy storage module 20 is ready to compensate for changes in the input current at any time by charging or discharging. Therefore, in the present disclosure, the reference signal Vref represents an average power of the power module 10, and the reference signal Vref is acquired by processing the current-sharing bus signal V_ishare. It should be understood that there are many manners to acquire the above reference signal Vref, for example, the reference signal Vref is an average value of the current-sharing bus sampling signal Vsamp over a period of time. Alternatively, the reference signal Vref is a value acquired by filtering the current-sharing bus sampling signal Vsamp, and the present disclosure does not limit this.

Specifically, the difference between the reference signal Vref and the current-sharing bus sampling signal Vsamp is compensated (for example, by a PI controller) to generate a current reference signal Iref corresponding to the bidirectional DC-to-DC converter 21. In the full power compensation approach, a selection unit selects a first loop a to output, that is, the current reference signal Iref is directly output without any adjustment. Furthermore, an error acquired by the difference between an inductor current sampling signal iL in the bidirectional DC-to-DC converter 21 and the current reference signal Iref is compensated by, for example but not limited to, a PI controller, to finally generate a control signal Duty to control a duty cycle of switches in the bidirectional DC-to-DC converter 21, so as to maintain the input current Iin unchanged. In the reduced power compensation approach, the selection unit selects a second loop b to output, that is, the current reference signal Iref is limited by a limiting unit. In this case, the control signal Duty to control the duty cycle of switches in the bidirectional DC-to-DC converter 21 is generated according to the limited current reference signal Iref and the inductor current sampling signal iL of the bidirectional DC-to-DC converter 21. Those skilled in the art should understand that the control loop can be implemented using an analog circuit or a digital circuit, and this embodiment is only used as an illustrative example.

Specifically, in some embodiments, the limiting unit is configured to limit the current reference signal Iref to not exceed a ratio of a power limit value Plimit to the voltage Vc of the energy storage unit 22, and to achieve the reduced power compensation approach by reducing the power limit value Plimit. Specifically, the limiting unit sets the maximum value Iref_limit of the current reference signal equal to the power limit value Plimit divided by the voltage Vc of the energy storage unit 22 (Iref_limit=Plimit/Vc). When the current reference signal Iref generated by the outer loop is greater than the maximum value Iref_limit, the current reference signal Iref is set equal to the maximum value Iref_limit as the reference of the inner loop. Conversely, when the current reference signal Iref is less than the maximum value Iref_limit, the current current reference signal Iref is directly used as the reference of the inner loop. In addition, in this manner, the reduced power compensation approach can be realized by gradually reducing the power limit value Plimit from the current power. Of course, the reduction of the power limit value Plimit may be in a progressive reduction or in a step reduction, or the reduction amplitude of the power limit value Plimit may be determined by at least one of the durations of the idle state of the load, the remaining compensable energy of the energy storage unit, and the preset compensation time.

It should be understood that the above embodiment is only an example of the reduced power compensation approach of the present disclosure, and any other specific implementation manner that can realize the reduced power compensation approach mentioned is within the protection scope of the present disclosure.

In summary, the present disclosure has the following features and advantages: selecting either the full power compensation approach or the reduced power compensation approach based on specific conditions to compensate the input current of the power module enables the input current to remain unchanged or fluctuate more gradually, thereby reducing the impact on the power grid.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A method of controlling an energy storage module, wherein the energy storage module comprises a bidirectional DC-to-DC converter and an energy storage unit and a first terminal of the bidirectional DC-to-DC converter is connected to the energy storage unit, the method comprising: controlling the energy storage module to operate in a charging mode when a load of a power module connected to a second terminal of the bidirectional DC-to-DC converter is in an idle state, and selecting a full power compensation approach or a reduced power compensation approach to compensate an input current of the power module according to a specific condition.

2. The method of controlling the energy storage module according to claim 1, further comprising: in the full power compensation approach, controlling an amplitude of the input current to maintain the amplitude of the input current unchanged before the load is in the idle state.

3. The method of controlling the energy storage module according to claim 1, further comprising: in the reduced power compensation approach, controlling an amplitude of the input current to be lower than the amplitude of the input current before the load is in the idle state and to slowly change.

4. The method of controlling the energy storage module according to claim 3, further comprising: in the reduced power compensation approach, controlling charging power of the energy storage unit to reduce so as to extend a charging time of the energy storage unit.

5. The method of controlling the energy storage module according to claim 1, further comprising: determining that the load is in the idle state when a duration that the energy storage module enters the charging mode exceeds a preset time.

6. The method of controlling the energy storage module according to claim 1, wherein the specific condition is determined by at least one of a duration of the idle state of the load, a remaining compensable energy of the energy storage unit, and a preset compensation time.

7. The method of controlling the energy storage module according to claim 1, wherein in a condition that the specific condition is determined by the duration of the idle state of the load, when the duration of the idle state of the load is less than a first time threshold, the full power compensation approach is selected; when the duration of the idle state of the load is greater than the first time threshold, the reduced power compensation approach is selected, or the full power compensation approach is selected first to compensate for a second time threshold and the reduced power compensation approach is then selected when the load is still in the idle state.

8. The method of controlling the energy storage module according to claim 1, wherein in a condition that the specific condition is determined by the remaining compensable energy of the energy storage unit, when the remaining compensable energy exceeds a first energy threshold, the full power compensation approach is selected; when the remaining compensable energy is lower than the first energy threshold, the reduced power compensation approach is selected, or the full power compensation approach is selected first and the reduced power compensation approach is then selected when the remaining compensable energy is lower than a second energy threshold.

9. The method of controlling the energy storage module according to claim 1, wherein in a condition that the specific condition is determined by the preset compensation time and the remaining compensable energy of the energy storage unit, when the remaining compensable energy is sufficient to keep the input current unchanged within the preset compensation time, the full power compensation approach is selected; when the remaining compensable energy is insufficient to keep the input current unchanged within the preset compensation time, the reduced power compensation approach is selected, or the full power compensation approach is selected first and the reduced power compensation approach is then selected.

10. The method of controlling the energy storage module according to claim 9, further comprising:
calculating the remaining compensable energy of the energy storage unit in real time,
acquiring a remaining compensation time according to a current charging power and the remaining compensable energy,
acquiring a time still required for compensation according to a difference between the preset compensation time and a compensated time, and
adjusting the compensation approach according to a relationship between the remaining compensation time and the time still required for compensation, wherein when the remaining compensation time is greater than the time still required for compensation, the full power compensation approach is selected; when the remaining compensation time is less than the time still required for compensation, the full power compensation approach is switched to the reduced power compensation approach so that the remaining compensation time is not less than the time still required for compensation.

11. The method of controlling the energy storage module according to claim 9, wherein the preset compensation time is a known time of the idle state of the load.

12. The method of controlling the energy storage module according to claim 11, wherein the known time of the idle state of the load is predicted according to an artificial intelligence algorithm.

13. The method of controlling the energy storage module according to claim 9, wherein the preset compensation time is a specified maximum duration of the load in the idle state.

14. The method of controlling the energy storage module according to claim 1, further comprising: controlling an operation state of the energy storage module according to a reference signal and a current-sharing bus signal provided by the power module.

15. The method of controlling the energy storage module according to claim 14, wherein the reference signal represents an average power of the power module.

16. The method of controlling the energy storage module according to claim 14, wherein the reference signal is acquired by processing the current-sharing bus signal.

17. The method of controlling the energy storage module according to claim 14, further comprising: in the full power compensation approach, acquiring a current-sharing bus sampling signal by sampling the current-sharing bus signal, generating a current reference signal corresponding to the bidirectional DC-to-DC converter according to a difference between the reference signal and the current-sharing bus sampling signal, and generating a control signal for controlling the bidirectional DC-to-DC converter according to the current reference signal and an inductor current of the bidirectional DC-to-DC converter so as to maintain the input current unchanged.

18. The method of controlling the energy storage module according to claim 14, further comprising: in the reduced power compensation approach, acquiring a current-sharing bus sampling signal by sampling the current-sharing bus signal, generating a current reference signal corresponding to the bidirectional DC-to-DC converter according to a difference between the reference signal and the current-sharing bus sampling signal, and generating a control signal for controlling the bidirectional DC-to-DC converter according to the current reference signal and an inductor current of the bidirectional DC-to-DC converter, wherein the reduced power compensation approach is implemented by limiting an amplitude of the current reference signal.

19. The method of controlling the energy storage module according to claim 18, wherein the current reference signal is set not to exceed to a ratio of a power limit value and a voltage of the energy storage unit, and the reduced power compensation approach is implemented by reducing the power limit value.

20. A energy storage module, comprising:
a bidirectional DC-to-DC converter and an energy storage unit, wherein a first terminal of the bidirectional DC-to-DC converter is connected to the energy storage unit, and a second terminal of the bidirectional DC-to-DC converter is connected to an output terminal of a power module; and each energy storage module further comprises a controller configured to execute the method in claim 1.

21. A power supply system, comprising:
at least one power module, wherein an output terminal of each power module is connected in parallel to a load, and each power module is configured to convert its own output current into a voltage signal to a current-sharing bus, and
at least one energy storage module, each energy storage module having an output terminal connected together, and each energy storage module comprising a bidirectional DC-to-DC converter and an energy storage unit, wherein a first terminal of the bidirectional DC-to-DC converter connected to the energy storage unit, and a second terminal of the bidirectional DC-to-DC converter connected to the output terminal of the power module, and each energy storage module further comprises a controller, configured to execute the method in claim 1; wherein the voltage signal on the current-sharing bus is the current-sharing bus signal.

22. The power supply system according to claim 21, wherein the at least one power module is disposed in the same power shelf; the at least one energy storage module is disposed in the same power shelf.
